(19) United States
(12) Patent Application Publication
(10) Pub. No.: US 2011/0205557 A1
(43) Pub. Date: Aug. 25, 2011

(54) Method for Printing a Simplex Print Job in Between Images of a Duplex Print Job

(76) Inventor: William Paul Cook, Lexington, KY (US)

(21) Appl. No.: 12/709,196

(22) Filed: Feb. 19, 2010

(51) Int. Cl. G06K 15/02

(52) U.S. Cl. 358/1.2

(57) ABSTRACT

A method for transferring images, to media sheets, of a simplex print job including a simplex image and a duplex print job including a first image and a second image received at an image forming apparatus having a duplexer and a media path having a duplex portion. During printing the second image of the duplex print job is printed on a first side of a first media sheet and the first media sheet is sent into duplexer and the duplex portion of the media path. Next, the first image of the simplex print job is transferred to a second media sheet and sent to an output bin, and finally the first image of the duplex print job is transferred to a second side of the first media sheet. The first image of the simplex print job is printed on the second media sheet while the first media sheet is traveling through the duplex portion of the media path of the image forming apparatus helping to increase image apparatus throughput.

### BACKGROUND

1. Field of the Invention

The present invention relates generally to a method for transferring images to media in an image forming apparatus and, more particularly, for transferring images of alternating simplex and duplex print jobs on to media in an image forming apparatus.

2. Description of the Related Art

An image forming apparatus, such as a color printer, typically includes an image transfer assembly having four units associated with four colors, black, magenta, cyan, and yellow. Each unit includes a laser printhead that is used to produce a latent image on the charged surface of a photoconductive unit. The latent image on each photoconductive unit is developed with the appropriate color toner and is then transferred to either an intermediate transfer medium or directly to a media sheet (such as paper) picked from a media input tray that travels past the photoconductive units in the image transfer assembly. The toner on the media is then fused to the media in a fuser assembly, and the media sheet is transported out of the image forming apparatus into an output bin.

The image forming apparatus may form an image on one or both sides of the media sheet. Where images are formed on only one side of the media sheet, such printing is known as simplex printing or one-sided printing. In two-sided printing, or duplex printing, an image is formed on one side of the media sheet and then the media sheet is returned into the device for printing of another image on the other side of the media sheet.

As used herein “sheet” or “media sheet” refers to the physical media on which printing occurs. A media sheet has a front side and a back side. An “image” as used herein is the information that is to be printed onto a side of a media sheet. A simplex print job having two images would be printed out on one side of two media sheets. A duplex job having two images would be printed out on the front and back side of a single media sheet. An image can be text, or graphics or combinations of these and may appear on the media sheet as one page or more than one page. The latter occurs, for example, when a printer is performing N-up printing where N is the number of pages that are to be printed on each side of the media sheet. For example, for 2-up simplex printing, if a file contains 9 pages, the physical document would be printed on five sheets four of which would have two pages printed on it (two pages on the front side, none on the back side) and one of which would have one page printed on it (one page on the front side, none on the back side). For 2-up duplex printing, if a file contains 9 pages, the physical document would be printed on three sheets two of which would have four pages printed on it (2 pages on each of the front and back sides) and one of which would have one page printed on it (one page on the front side and none on the back side)

FIG. 1 illustrates a timing diagram for printing a four image duplex print job having one image per side of the media sheet according to a prior art system using a peek-a boo duplex system with two media sheets in a media path. The media path has a primary or simplex portion that extends from a media input tray past an image transfer assembly where the image is transferred to a side of the media sheet and exits at an output bin that receives the printed media sheets. A duplex portion of the media path begins adjacent the output bin and ends adjacent the feed rollers that move the media sheet past the image transfer assembly within the printer.

With a peek-a-boo duplex system, a typical method is to print one side of the media sheet, move the media sheet most of the way into an output bin using a pair of driven exit rollers and then pull the media sheet into the duplex portion of the media feed path by reversing the direction of the exit rollers. The media sheet in the duplex portion of the media path then reenters the primary portion of the media path prior to an image transfer assembly allowing the back side of the media sheet to be printed.

The four image duplex print job includes four ordered images, i.e., a first image (1), a second image (2), a third image (3), and a fourth image (4). The four image duplex print job is printed in a 2-4-1-3 sequence, i.e., the second image is printed first, followed by the fourth image, then the first image, and finally the third image is printed. This may also be termed a 4 image sequence.

During the 2-4-1-3 print sequence, the second image is printed on a first side of a first media sheet and the first image is printed on the back side of the first media sheet. When the first media sheet is moving in the duplex portion, the fourth image is transferred to a first side of a second media sheet. Next, when the second media sheet is traveling through the duplex portion the first image is printed on the second side of the first media sheet, and finally the third image is printed on the second side of the second media sheet. The time 10 between printing of the second image and the fourth image and between the fourth image and the first image are approximately equal. The time 10 between the second and fourth images is needed to allow the first media sheet to move out of the way of the second media sheet as the first sheet is retracted back into the duplex portion of the media path. Similarly for the time 10 between the printing of the fourth image and the first image. The second media sheet bearing the fourth image must be retracted back into the duplex portion of the media path to allow the first media sheet exiting the duplex portion of the media path to be imprinted on its back side with the third image. The time 11 between printing of the first image and the third image is shorter than time 10 as the second sheet need only wait for the first sheet to exit the image transfer area (where it goes into the output bin) before proceeding into the image transfer area.

As discussed above, in the 2-4-1-3 print sequence there are two media sheets, the first and the second, in the image forming apparatus at one time. This results in utilization of the time during which one of the media sheets is traveling in the duplex path, resulting in improved efficiency of the image forming apparatus during printing of duplex print jobs requiring an even number of media sheets to receiving printed images.

The 2-4-1-3 print sequence is not efficient when the duplex print job requires an odd number of media sheets. Further, in the 2-4-1-3 sequence, if a simplex print job, i.e., a print job having a single image, is received by the image forming apparatus before receiving the images of a duplex print job, the single image of the simplex print job would be printed either before or after printing the images of the duplex print job. This is because the time 10 between transferring the images of the duplex print job in the 2-4-1-3 sequence is too short to transfer the single image of the simplex print job.

FIG. 2 illustrates a timing diagram for a duplex print job having a single media sheet in the media path according to the prior art system. This timing, known as the two image duplex, is used at various times, including the final media sheet of a duplex print job with an odd number of sheets and when a duplex print job requires only a single media sheet to be printed on both sides.

The two image sequence has only one media sheet traversing the media path in the image forming apparatus at one time. The images in the two image sequence are printed in a 2-1-4-3 sequence. As shown in FIG. 2, a time 20, that is longer relative to time 10 is present between transferring the images 2 and 1, and between transferring the images 4 and 3, as the media sheet has to be retracted and moved through the duplex portion of the media path of the image forming apparatus before imaging the second side of the media sheet. There is adequate time between imaging the images, i.e., 2 and 1, and 4 and 3, of the duplex print job for imaging an image of a simplex print job. However, a following simplex image cannot simply be advanced to fill in the time 20 between the images of the duplex print job, since the resulting sheets for both the simplex and duplex print jobs would be stacked out of order by the image forming apparatus.

In the prior art systems, a typical duplex print job having job length requiring that three sides of media sheets be printed, and assuming one image per media sheet side, would mean that the first two images were printed in duplex printing on the front and back sides of the first media sheet and the third image was printed in simplex printing on the front side of the second media sheet. In transition between the simplex printing and the duplex printing, the duplex path of the image forming apparatus has to be filled and emptied before the simplex printing, which causes inefficiencies with a single sheet of media going around the entire media path comprised of the simplex and duplex portions, and generating a large inter-page gap between it and a previously printed media sheet. If three sided print duplex print jobs are repeated, such as when making multiple copies, a repeating pattern of a single media sheet having two printed sides and a single media sheet having one printed side results. In this case, the duplex portion of the media path is consistently underutilized, with only a single media sheet being processed at a time in the image forming apparatus. Thus, the resulting throughput of the image forming apparatus in case of alternating simplex and duplex print jobs is much slower compared to a duplex print job requiring an even number of media sheets.

Therefore, it would be advantageous to have a system that can print an alternating sequence of simplex and duplex printing of media sheet with improved efficiency.

### SUMMARY OF THE INVENTION

A method of printing a simplex print job with a duplex print job in an image forming apparatus having a duplexer and a media path including a duplex portion, comprises receiving a plurality of print jobs including at least one simplex print job and a duplex print job, a simplex image included in each of the at least one simplex print job, and a first image and a second image included in the duplex print job; determining if the simplex image in the at least one simplex print job is followed by a duplex image; and determining that a time travel of a media sheet in the duplex portion of the media path permits printing of N simplex images on N media sheets then transferring the second image in the duplex print job to a first side of the first media sheet, sending the first media sheet into the duplexer and the duplex portion of the media path, and, for each N simplex image, transferring the N image in the at least one simplex print job to a first side of the N media sheet; and sending each N media sheet to an output bin, and retrieving the first media sheet from the duplex portion of the media path and transferring the first image in the duplex print job to a second side of the first media sheet.

The method may further comprise having N=1 and sending the first media sheet into a peek-a-boo duplexer.

Another form of the invention is a method of printing a simplex print job with a duplex print job in an image forming apparatus having a duplexer and a media path including a duplex portion, that comprises, receiving a plurality of print jobs including at least one simplex print job and a duplex print job, a simplex image included in each of the at least one simplex print job, and a first image and a second image included in the duplex print job; determining if the simplex image in the at least one simplex print job is followed by a duplex image; and when at least one of the following conditions occurs: (1) the duplex print job is at the end of the print queue and (2) the duplex print job is followed by a second simplex image, then, transferring the second image in the duplex print job to a first side of the first media sheet, sending the first media sheet into the duplexer and the duplex portion of the media path, transferring the image in the at least one simplex print job to a first side of a second media sheet, sending the second media sheet to an output bin, and retrieving the first media sheet from the duplex portion of the media path and transferring the first image in the duplex print job to a second side of the first media sheet.

Other conditions include a 3-sheet duplex print sequence being used. Further, after determining said conditions, the method provides for determining if a time travel of a media sheet in the duplex portion of the media path permits printing of N simplex images on N media sheets and if so then after transferring the Nth image in the simplex job to a first side of a second media sheet transferring the remaining N-1 images to subsequent N-1 media sheets. The method provides for the first media sheet and at least one of the N media sheets traveling through the media path of the image forming apparatus at a time. The method may further provide N=1 and sending the first media sheet into a peek-a-boo duplexer.

In a still further embodiment there is provided a method of printing a simplex print job with a duplex print job in an image forming apparatus having a peek-a-boo duplexer and a media path including a duplex portion, comprising: receiving a simplex print job and a duplex print job, a first image included in the simplex print job, and a first image and a second image included in the duplex print job; transferring the second image in the duplex print job to a first side of the first media sheet; sending the first media sheet into the peek-a-boo duplexer and the duplex portion of the media path; transferring the first image in the simplex print job to a first side of a second media sheet; sending the second media sheet to an output bin; retrieving the first media sheet from the duplex portion of the media path and transferring the first image in the duplex print job to a second side of the first media sheet; and sending the first media sheet to the output bin. Further prior to transferring the second image in the duplex print job to the first side of the first media sheet, the method determines if a simplex image is followed by a duplex image; if NO, then a simplex image sequence for printing of the simplex print job and a duplex image sequence for printing the duplex print job is used; and if YES, then the method determines if the duplex printing job is at an end of a print queue; if YES, the transfer of the second image in the duplex print job is done; if NO, the method determines if the duplex print job is followed by a simplex image; if YES, then the transfer of the second image in the duplex print job is done; and if NO, a simplex image sequence for printing the simplex print job and a duplex image sequence for printing the duplex print job is used.

In a still further embodiment a method of printing a simplex print job with a duplex print job in an image forming apparatus having a duplexer and a media path including a duplex portion, comprises receiving a plurality of print jobs including at least one simplex print job and a duplex print job, a simplex image included in each of the at least one simplex print job, and a first image and a second image included in the duplex print job; determining if the simplex image in the at least one simplex print job is followed by a duplex image; and when at least one of the following conditions occurs: (1) the duplex print job is at the end of the print queue, (2) the duplex print job is followed by a second simplex image and (3) a 3-sheet duplex print sequence being used, then determining if a time travel of a media sheet in the duplex portion of the media path permits printing of N simplex images on N media sheets; transferring the second image in the duplex print job to a first side of the first media sheet; sending the first media sheet into the duplexer and the duplex portion of the media path; for each N simplex image, transferring the N image in the at least one simplex print job to a first side of N media sheet; and sending each N media sheet to an output bin; then retrieving the first media sheet from the duplex portion of the media path and transferring the first image in the duplex print job to a second side of the first media sheet.

Additional features and advantages of the invention will be set forth in the detailed description which follows, and in part will be readily apparent to those skilled in the art from that description or recognized by practicing the invention as described herein, including the detailed description, which follows, the claims, as well as the appended drawings.

Each of the several embodiments may also include storing the simplex print job and the duplex print job in a memory of the image forming apparatus.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 illustrates a timing diagram for a four image duplex printing job having four printed sides on two media sheets according to a prior art system using a peek-a-box duplexer;

FIG. 2 illustrates a timing diagram for a duplex print job having an odd number printed sides according to the prior art system of FIG. 1;

FIG. 3 is a side elevational view of an image forming apparatus according to the present invention;

FIG. 4 is a flowchart illustrating an imaging process by the image forming apparatus according to one embodiment of the present invention;

FIGS. 5A-5C illustrate partial view of the image forming apparatus performing the imaging process of FIG. 4; and

FIG. 6A illustrates a timing diagram for printing a simplex print job of a single simplex image within a duplex print job; and

FIG. 6B illustrates a timing diagram for printing a simplex print job where the media sheet travel time through the duplex portion of the media path allows multiple simplex print jobs to be printed.

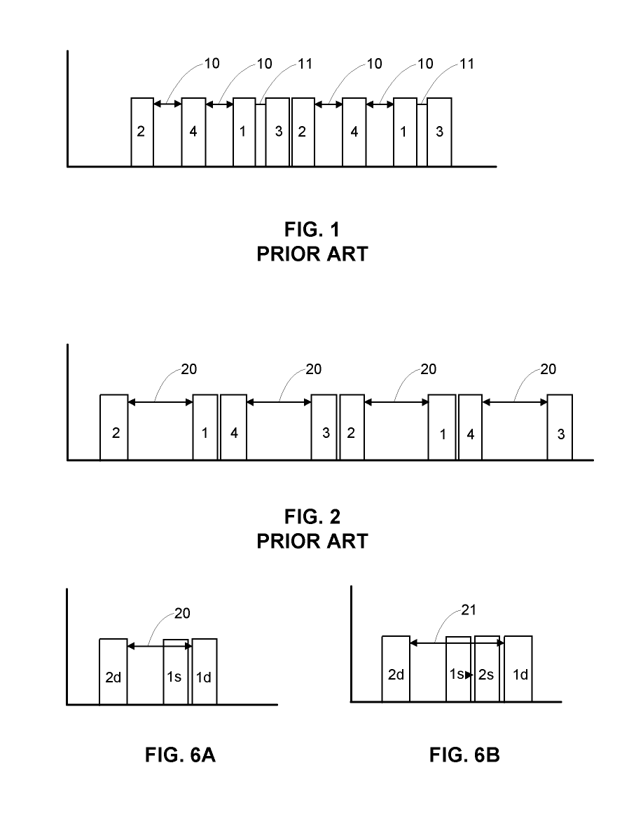

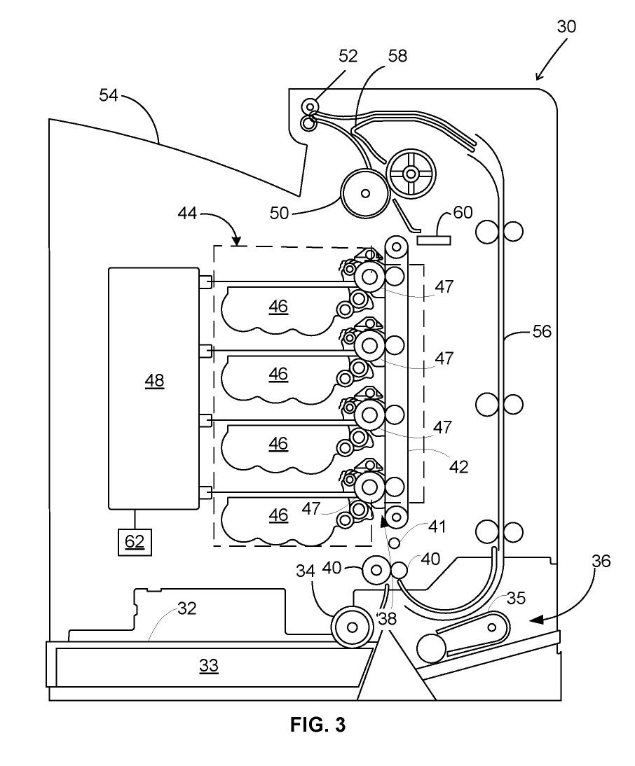

### DETAILED DESCRIPTION

Reference will now be made in detail to the exemplary embodiment(s) of the invention, as illustrated in the accompanying drawings. Whenever possible, the same reference numerals will be used throughout the drawings to refer to the same or like parts.

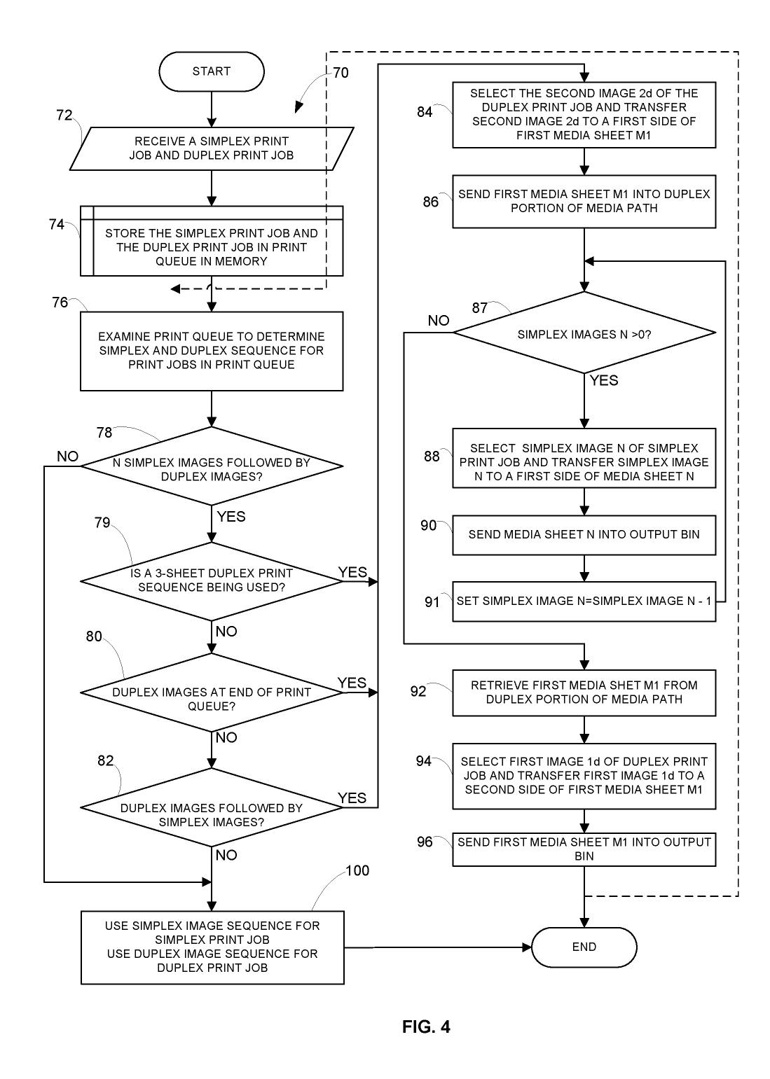

FIG. 3 illustrates an image forming apparatus 30 according to the present invention. The image forming apparatus 30 includes a media tray 32 having a stack 33 of media sheets and a pick mechanism 34, or a manual input 36 having pick mechanism 35, for introducing a media sheet in the image forming apparatus 30. Media from the media tray 32 or the manual input 36 are fed into a primary portion 38 of the media path by feed rollers 40. One or more registration rollers 41 are disposed along the primary portion 38 to align a media sheet and precisely control its further movement along the primary portion 38 of the media path. A media transport belt 42 forms a section of the primary media path 38 for moving a media sheet past an image transfer assembly 44. The image transfer assembly 44 includes a plurality of image forming units 46. A processor 48 controls the operation of the image forming apparatus including media sheet picking and movement along the media path.

As illustrated in FIG. 3, the image forming apparatus 30 includes four image forming units 46 for transferring print material on the media sheet to produce a full color image. The image forming units 46 are disposed along a vertical plane. The print material typically comprises toner of varying colors. For illustrative purposes, the image forming units 46 include cyan, magenta, yellow, and black toner to produce a full-color image on the media sheet.

An imaging device (not shown) forms an electrical charge on a photoconductive units 47 within the image forming units 46 as part of the image formation process. Various imaging devices may be used such as a laser printhead or a LED printhead.

A media sheet with toner from one or more image forming units 46 is then moved through a fuser 50 that fuses the toner to the media sheet. Exit rollers 52 rotate in a forward or a reverse direction to move the media to an output tray 54 or a duplex path 56. When the media is moved to the output tray 54, the exit rollers 52 rotate in a forward direction and the media is expelled into the output tray 54. For duplex printing, exit rollers 52 rotate in a forward direction until the trailing edge of the media moves beyond the diverter 58. The exit rollers 52 then reverse direction and drive media sheet into the duplex portion 56 of the media path. The duplex path 56 directs the inverted media sheet back through the image formation process for forming an image on a second side of the media.

A sensor 60 is positioned along the primary portion 38 of the media path to detect the leading edge and trailing edge of a media sheet. The image forming apparatus 30 also includes a memory 62. The information from the sensor 60 is forwarded to the processor 48, which oversees the timing of the image formation process. The processor 48 also controls the transfer of the toner image on to the media, as well as the movement of the media through the primary portion 38 and the duplex portion 56 of the media path.

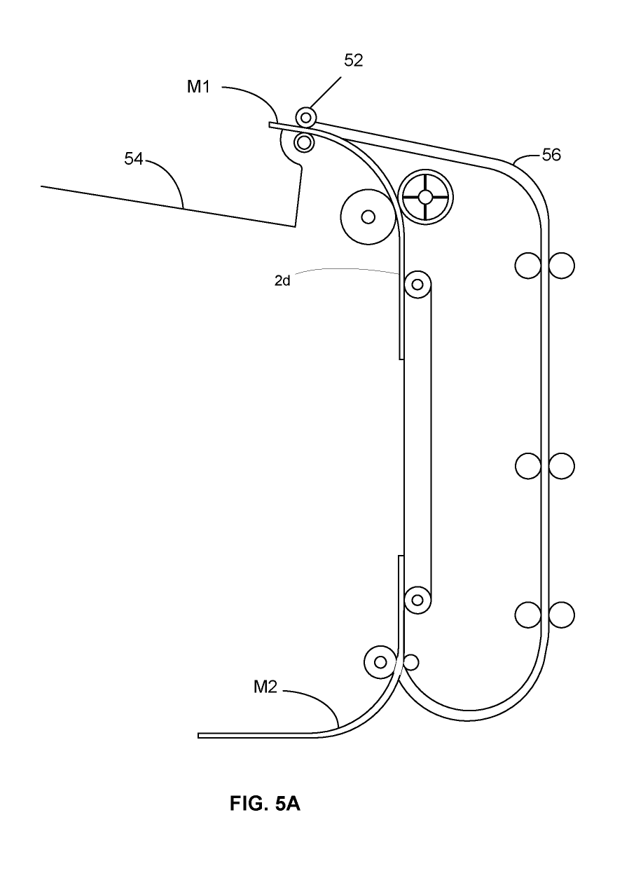

FIG. 4 is a flowchart illustrating an imaging process 70 by the image forming apparatus 30 according to one embodiment of the present invention. Process 70 is a general process allowing for multiple simplex media sheets to be printed between the first side and back side of the duplex printed media sheet. The peek-a-boo duplexer described has a duplex portion 56 of the media path where the media sheet travel time within the duplex portion 56 will only allow a single simplex media sheet to be printed. However for media paths having longer duplex portions, the media sheet travel time can be such that multiple simplex media sheets can be printed. Initially at block 72, a simplex print job and a duplex print job are received by the image forming apparatus 30. The print jobs, received by the image forming apparatus 30, include a plurality of images, including in the general case, N simplex images to be printed on a first side of N simplex media sheets, and is a specific example described previously a first image 1s to be printed on a first side of a media sheet M2 for the simplex print job, and a first image 1d and a second image 2d to be printed on the first and second sides of a media sheet M1 for the duplex print job. The images in each of the print jobs may be text, image, or a combination thereof.

At block 74, the simplex print job and the duplex print job are stored in the print queue in memory 62 of the image forming apparatus 30. Next, at block 76, processor 48 examines the print queue to determine the simplex and duplex sequences for the print jobs in the print queue.

At block 78, a determination is made if N simplex images are followed by duplex images. For the specific example, N=1. If NO, then at block 100 a simplex image sequence is used for printing of the simplex print job followed by a duplex image sequence used for printing of the duplex print job. If YES, then at block 79, a determination is made if a 3-sheet duplex print sequence is being used. A 3-sheet duplex print sequence is one where a blank image is left at the start of the duplex sequence regardless of the length of the print job. In this case being determined in block 79, the N simplex images are limited to a count of 1. If YES, process 70 proceeds to block 84. If NO, process 70 proceeds to block 80.

At block 80 a determination is made if the duplex images are at the end of the print queue. If YES, process 70 proceeds to block 84. If NO, at block 82 a determination is made if the duplex images are to be followed by simplex images. If YES, the process 70 proceeds to block 84. If NO, the process proceeds to block 100 where a simplex image sequence is used for printing of the simplex print job followed by a duplex image sequence used for printing of the duplex print job. The simplex image and duplex image printing sequences in block 100 may be any type of image printing sequences.

After a YES determination is made at any of blocks 79, 80, or 82, at block 84 processor 48 proceeds with executing the 2d-1s-1d image printing sequence and processor 48 selects the second image 2d of the duplex print job stored in the memory 62 and provides instructions to the image forming apparatus 30 for transferring the second image 2d to a first side of a first media sheet M1.

As one of ordinary skill in the art would recognize the sequence of determinations in blocks 79, 80, and 82 may be performed in any order without departing from the scope of the present invention. In general the determinations being performed in blocks 79, 80 and 82 are determining if the travel time through the duplex portion of the media path is long enough to print N simplex images.

At block 86 the first media sheet M1 is sent into the duplex portion 56 of the media path. At block 87 a determination is made if the number of simplex images is greater than zero. If NO, process 70 proceeds to block 92 to complete the duplex print job. If YES, process 70 proceeds to block 88.

At block 88, the processor 48 in the general case selects one of the N simplex images in the simplex print job and transfers it to a first side of media sheet N. In the specific example, processor 48 selects the first image is of the simplex print job stored in the memory 62 and provides instructions to the image forming apparatus 30 for transferring the first image 1s to a first side of a second media sheet M2.

At block 90 media sheet N in the general case, and the second media sheet M2 in the specific example is sent into output bin 54. At block 91, the count of N simplex images is reduced by one and process 70 returns to block 87.

At block 92 the first media sheet M1 is retrieved from the duplex portion 56 of the media path.

At block 94 processor 48 selects the first image 1d of the duplex print job stored in the memory 62 and provides instructions to the image forming apparatus 30 for transferring the first image 1d to a second side of the first media sheet M1.

At block 96 the first media sheet M1 is sent to the output bin 54. If desired the process may return to block 76 as shown by the dashed line.

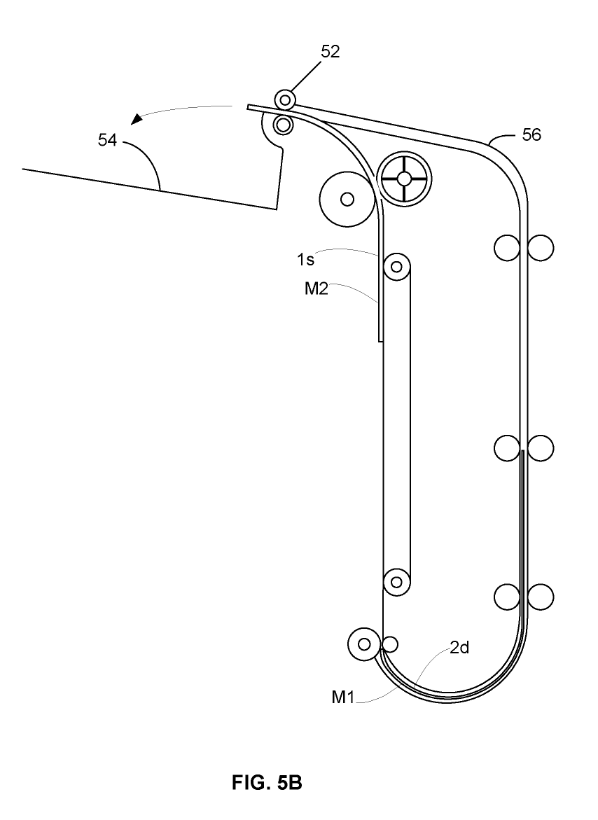

FIGS. 5A-5C illustrate a partial view of the image forming apparatus 30 performing the imaging process of FIG. 4. The order in which the media sheet is placed for imaging in the media tray 32 of the image forming apparatus 30 is a first media sheet M1 having a first side and a second side, and a second media sheet M2 having a first side and a second side. As noted above in block 72, the image forming apparatus 30 receives the simplex print job including the first image 1s to be printed on one of the sides of a media sheet and the duplex print job including the first image 1d and the second image 2d to be printed on the opposite sides of a singe media sheet.

As shown in FIG. 5A, the second image 2d of the duplex print job is transferred to the first side of the first media sheet M1. After the second image 2d of the duplex print job is transferred to the first side of the first media sheet M1, the first media sheet M1 is partially ejected from the image forming apparatus 30 by the exit rollers 52. The exit rollers 52 then reverse direction and the first media sheet M1 is fed into the duplex portion 56 of the media path. The time required for performing the duplex operation, i.e., the time required for the first media sheet M1 to partially eject from the image forming apparatus 30, the exit rollers 52 to reverse direction of the first media sheet M1, and the first media sheet M1 to travel through the duplex portion 56 of the media path back to the primary portion 38 of the media path, is sufficient to pass another media sheet through the primary portion 38 of the media path and print an image of a simplex print job on to the media sheet.

As shown in FIG. 5B, the first image is of the simplex print job is then transferred to the first side of the second media sheet M2. During the transfer of the first image 1s of the simplex print job to the second media sheet M2, the first media sheet M1 is moving through the duplex path 56.

Finally, as shown in FIG. 5C, the second media sheet M2 having the first image 1s then exits into the output tray 54. The second image 2d of the duplex print job is transferred to the second side of the first media sheet M1. After the second image 2d is transferred to the first media sheet M1, it exits into on the output tray 54 on top of the second media sheet M2.

Processor 48 maintains a time interval or an inter-page gap between transferring the second image 2d of the duplex print job to the first side of the first media sheet M1 and transferring the first image 1d of the duplex print job to the second side of the first media sheet M1. Processor 48 also provides instructions to the image forming apparatus 30 for transferring the first image is of the simplex print job to the first side of the second media sheet M2 during this time interval or inter-page gap, and between the printing of images 2d and 1d of the duplex print job.

Printing the first image 1s of the simplex print job in between the images 2d and 1d of the duplex print jobs utilizes the time when the media sheet on to which the duplex image is being transferred is traveling the duplex path 56. This printing sequence of 2d is and 1d results in an improved efficiency for these types of print jobs in the image forming apparatus 30 when printing a simplex print job and a duplex print job next to one another in a print queue.

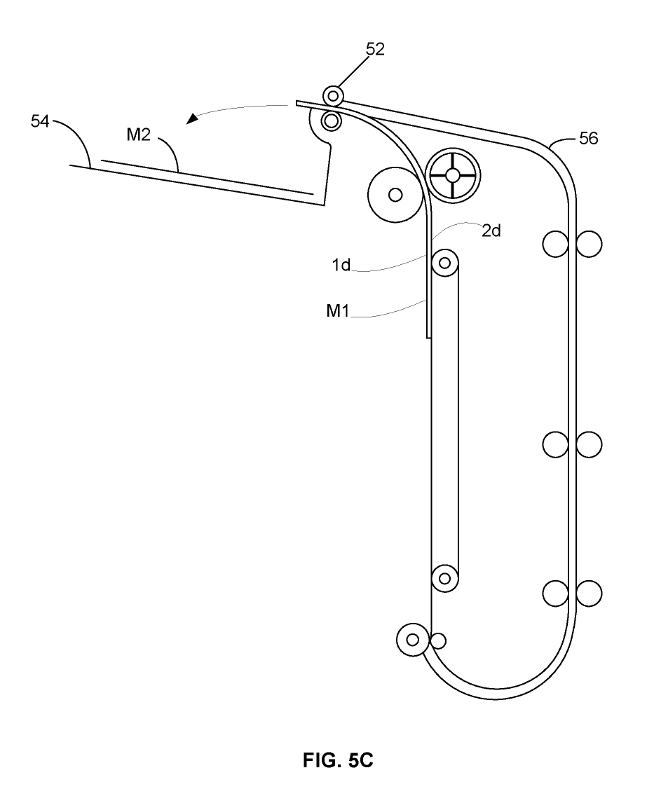

The printing sequence of the specific example of 2d-1s-1d as described in process 70 is illustrated in FIG. 6A. As shown the simplex image 1s is printed in the time period 20 in which the first media sheet M1 having the second duplex image 2d printed on a first side of the media sheet M1 as it travels through the duplex portion 56 of the media path, where the duplex portion 56 can only accommodate a single media sheet. In FIG. 6B, N simplex images, where N=2 are shown being printed in the time period 21 in which the first media sheet M1 having the second duplex image 2d printed on a first side of the media sheet M1 as it travels through the duplex portion 56 of the media path, where the duplex portion 56 is longer and can accommodate multiple media sheets. The time period 21 is greater than time period 20 due to the longer length in the duplex portion of the media path allowing for the printing of the two simplex images 1s and 2s while media sheet M1 is traversing the longer duplex portion of the media path.

The printing sequence 2d-1s-1d can be followed by a longer sequence of duplex printed media sheets printed using the 4 image duplex sequence where the following duplexed media sheets are offset by one media sheet. If the duplex print job requires an odd number of media sheets, the print job using the 4 image duplex sequence has to use the 2 image duplex sequence to print the last media sheet decreasing printer throughput. However if, for example, multiple copies of a 7 image duplex print job requiring seven printed sides is being printed, use of the 2d-1s-1d sequence increases the printer throughput. In this example the 7 images would be printed using the sequence of 2-4-1-3 for images 3, 4, 5 and 6 and then the 2d-1s-1d sequence for images 1, 7 and 2. Thus, in this example, the duplex print job is treated as a combination of a duplex print job and a simplex print job.

In tests conducted on a Model x736 multifunction printer scanner copier having a peek-a-boo duplexing system as described and manufactured by Lexmark International, Inc., the timing described in process 70 improves printer throughput by about 25 percent at a 35 page per minute operation given a repeating pattern of duplex pages and simplex pages, occurring for example in a print job that requires three printed media sides being copied multiple times.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of printing a simplex print job with a duplex print job in an image forming apparatus having a duplexer and a media path including a duplex portion, comprising:
receiving a plurality of print jobs including at least one simplex print job and a duplex print job, a simplex image included in each of the at least one simplex print job, and a first image and a second image included in the duplex print job;
determining if the simplex image in the at least one simplex print job is followed by a duplex image; and
determining that a time travel of a media sheet in the duplex portion of the media path permits printing of N simplex images on N media sheets then:
transferring the second image in the duplex print job to a first side of the first media sheet;
sending the first media sheet into the duplexer and the duplex portion of the media path; and
for each N simplex image:
transferring the N image in the at least one simplex print job to a first side of the N media sheet; and
sending each N media sheet to an output bin;
and
retrieving the first media sheet from the duplex portion of the media path and transferring the first image in the duplex print job to a second side of the first media sheet.

2. The method of claim 1, further comprising storing the simplex print job and the duplex print job in a memory of the image forming apparatus.

3. The method of claim 1, further comprising N=1 and sending the first media sheet into a peek-a-boo duplexer.

4. A method of printing a simplex print job with a duplex print job in an image forming apparatus having a duplexer and a media path including a duplex portion, comprising:
receiving a plurality of print jobs including at least one simplex print job and a duplex print job, a simplex image included in each of the at least one simplex print job, and a first image and a second image included in the duplex print job;
determining if the simplex image in the at least one simplex print job is followed by a duplex image; and
when at least one of the following conditions occurs: (1) the duplex print job is at the end of the print queue and (2) the duplex print job is followed by a second simplex image, then:
transferring the second image in the duplex print job to a first side of the first media sheet;
sending the first media sheet into the duplexer and the duplex portion of the media path;
transferring the image in the at least one simplex print job to a first side of a second media sheet;
sending the second media sheet to an output bin; and
retrieving the first media sheet from the duplex portion of the media path and transferring the first image in the duplex print job to a second side of the first media sheet.

5. The method of claim 4 wherein said conditions further includes a 3-sheet duplex print sequence being used.

6. The method of claim 4 wherein after determining said conditions, determining if a time travel of a media sheet in the duplex portion of the media path permits printing of N simplex images on N media sheets and if so then after transferring the Nth image in the simplex job to a first side of a second media sheet transferring the remaining N-1 images to subsequent N-1 media sheets.

7. The method of claim 6, wherein the first media sheet and at least one of the N media sheets are traveling through the media path of the image forming apparatus at a time.

8. The method of claim 4, further comprising storing the at least one simplex print job and the duplex print job in a memory of the image forming apparatus.

9. The method of claim 6, further comprising N=1 and sending the first media sheet into a peek-a-boo duplexer.

10. A method of printing a simplex print job with a duplex print job in an image forming apparatus having a peek-a-boo duplexer and a media path including a duplex portion, comprising:
receiving a simplex print job and a duplex print job, a first image included in the simplex print job, and a first image and a second image included in the duplex print job;
transferring the second image in the duplex print job to a first side of the first media sheet;
sending the first media sheet into the peek-a-boo duplexer and the duplex portion of the media path;
transferring the first image in the simplex print job to a first side of a second media sheet;
sending the second media sheet to an output bin;
retrieving the first media sheet from the duplex portion of the media path and transferring the first image in the duplex print job to a second side of the first media sheet; and
sending the first media sheet to the output bin.

11. The method of claim 10 wherein prior to transferring the second image in the duplex print job to the first side of the first media sheet, determining if a simplex image is followed by a duplex image;
if NO, then using a simplex image sequence for printing of the simplex print job and a duplex image sequence for printing the duplex print job; and
if YES, then determining if the duplex printing job is at an end of a print queue;
if YES, proceeding with the transfer of the second image in the duplex print job;
if NO, determining if the duplex print job is followed by a simplex image;
if YES, then proceeding with the transfer of the second image in the duplex print job; and
if NO, using a simplex image sequence for printing the simplex print job and a duplex image sequence for printing the duplex print job.

12. The method of claim 10, wherein the first media sheet and the second media sheet are traveling through the media path of the image forming apparatus at a time.

13. The method of claim 10, further comprising storing the simplex print job and the duplex print job in a memory of the image forming apparatus.

14. A method of printing a simplex print job with a duplex print job in an image forming apparatus having a duplexer and a media path including a duplex portion, comprising:
receiving a plurality of print jobs including at least one simplex print job and a duplex print job, a simplex image included in each of the at least one simplex print job, and a first image and a second image included in the duplex print job;
determining if the simplex image in the at least one simplex print job is followed by a duplex image; and
when at least one of the following conditions occurs: (1) the duplex print job is at the end of the print queue, (2) the duplex print job is followed by a second simplex image and (3) a 3-sheet duplex print sequence being used, then:
determining if a time travel of a media sheet in the duplex portion of the media path permits printing of N simplex images on N media sheets;
transferring the second image in the duplex print job to a first side of the first media sheet;
sending the first media sheet into the duplexer and the duplex portion of the media path;
for each N simplex image:
transferring the N image in the at least one simplex print job to a first side of N media sheet; and
sending each N media sheet to an output bin;
and
retrieving the first media sheet from the duplex portion of the media path and transferring the first image in the duplex print job to a second side of the first media sheet.

15. The method of claim 16, further comprising:
storing the simplex print job and the duplex print job in a memory of the image forming apparatus.

16. The method of claim 14, further comprising N=1 and sending the first media sheet into a peek-a-boo duplexer.
